(19) United States
(12) Patent Application Publication
(10) Pub. No.: US 2014/0324459 A1
(43) Pub. Date: Oct. 30, 2014

(54) AUTOMATIC HEALTH MONITORING ALERTS

(71) Applicant: HTI IP, L.L.C, Atlanta, GA (US)

(72) Inventor: James R. BARFIELD, Atlanta, GA (US)

(73) Assignee: HTI IP, L.L.C, Atlanta, GA (US)

(21) Appl. No.: 13/873,496

(22) Filed: Apr. 30, 2013

(51) Int. Cl. G06F 19/00

(52) U.S. Cl. CPC G06F 19/3418
USPC 705/3

(57) ABSTRACT

A device may receive information that identifies a first health metric value associated with a user and a first time, and may receive information that identifies a second health metric value associated with the user and a second time that is different from the first time. The device may receive medical record information associated with the user and a third time, where the medical record information is different from the first health metric value and the second health metric value. The device may infer a relationship between the first health metric value, the second health metric value, and the medical record information, based on the first time, the second time, and the third time. The device may provide an indication of the inferred relationship.

### BACKGROUND

A mobile personal emergency response system (MPERS) may be designed to signal the presence of a hazard requiring medical attention and/or to summon emergency response personnel to assist in a medical emergency. For example, an MPERS may include a transmitter that can be activated in the event of an emergency. The transmitter may transmit an alarm to an alarm monitoring company's central station, or to a telephone number associated with emergency response personnel. Emergency response personnel may then be dispatched to a site where the transmitter was activated.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for storing health metric values and medical record information associated with a user;

FIG. 5 is a diagram of an example implementation relating to the example process shown in FIG. 4;

FIG. 6 is a diagram of an example data structure for storing health metric values and medical record information associated with one or more users;

FIG. 7 is a flow chart of an example process for inferring health information associated with a user;

FIG. 8 is a diagram of an example implementation relating to the example process shown in FIG. 7;

FIG. 9 is a flow chart of an example process for generating and providing a health alert based on an analysis of a health metric value and/or medical record information; and

FIGS. 10A and 10B are diagrams of an example implementation relating to the example process shown in FIG. 9.

### DETAILED DESCRIPTION OF PREFERRED EMBODIMENTS

The following detailed description of example implementations refers to the accompanying drawings. The same reference numbers in different drawings may identify the same or similar elements.

A mobile personal emergency response system (MPERS) may monitor health metrics of a user, such as a user's heart rate, glucose level, blood pressure, activity level, etc. The MPERS may detect a change in a health metric, such as a change in heart rate. The MPERS may alert a medical provider when such a change requires medical attention. However, the medical provider may not receive any information regarding a cause of the change in the user's health metric, such as a reason why the user's heart rate experienced a change. Implementations described herein may provide a medical provider with information regarding a cause of a change in a user's health metrics, as monitored by an MPERS.

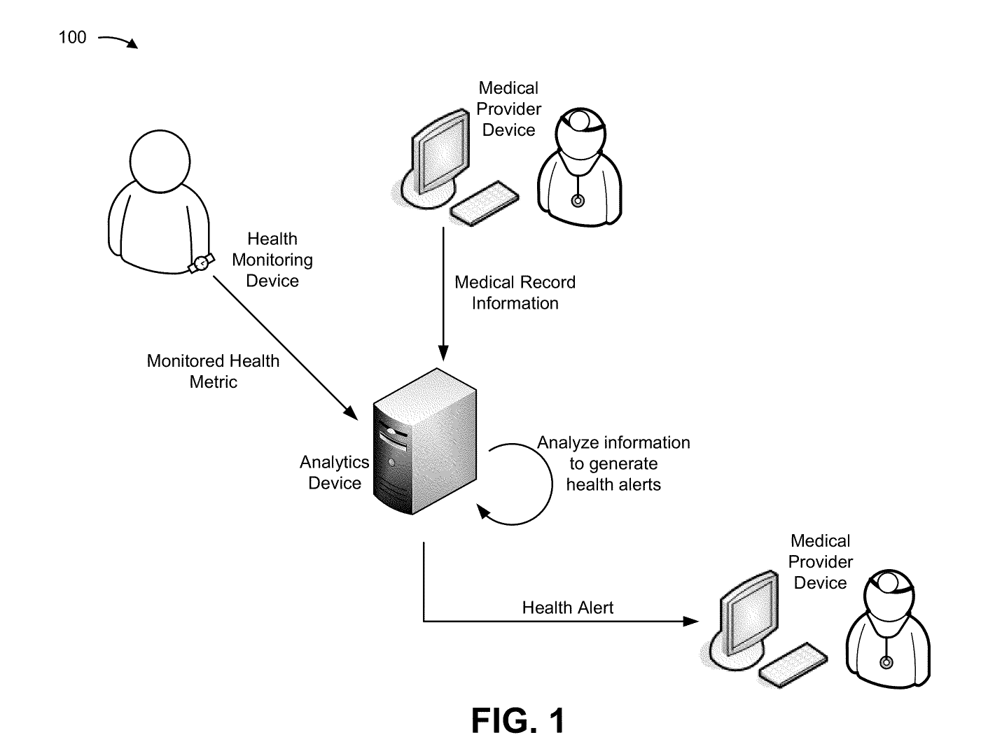

FIG. 1 is a diagram of an overview of an example implementation 100 described herein. As shown in FIG. 1, a user may be equipped with a health monitoring device, such as an MPERS that monitors one or more health metrics associated with the user. For example, the health monitoring device may monitor the user's activity level, heart rate, glucose level, etc. The health monitoring device may include various sensors to monitor the health metrics, and/or may receive the health metrics from other devices that monitor the health metrics of the user. The health monitoring device may transmit (e.g., via a wireless connection) the health metrics to an analytics device, such as a server.

As further shown in FIG. 1, a medical provider (e.g., a doctor, a nurse, a caregiver, etc.), may input medical record information, associated with the user, to a medical provider device, such as a computer. The medical provider device may transmit the medical record information to the analytics device. The analytics device may analyze the health metrics and/or the medical record information, and may generate a health alert based on the analysis. For example, the analytics device may determine that a health metric has changed over time, and may infer a cause of the change based on the medical record information. The analytics device may provide the health alert, including information that identifies the change in the health metric and/or the inferred cause of the change, to the medical provider device (and/or to a device associated with the user). In this way, a medical provider can be warned about a medical situation where the user requires medical attention, and may be able to make more intelligent decisions regarding providing medical attention due to receiving information describing an inferred cause of the medical situation.

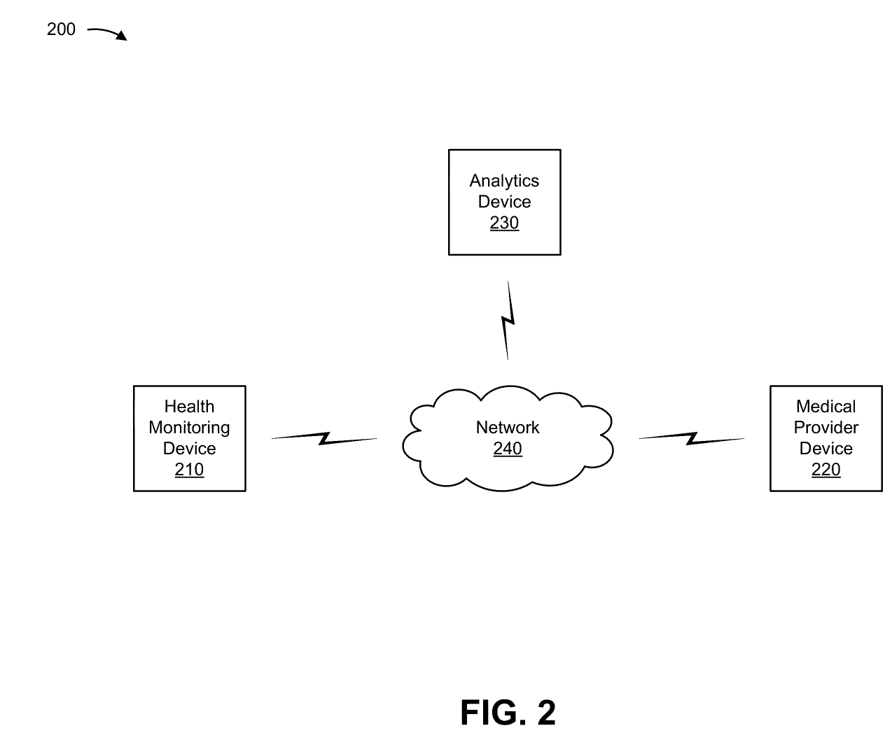

FIG. 2 is a diagram of an example environment 200 in which systems and/or methods described herein may be implemented. As shown in FIG. 2, environment 200 may include a health monitoring device 210, a medical provider device 220, an analytics device 230, and a network 240. Devices of environment 200 may interconnect via wired connections, wireless connections, or a combination of wired and wireless connections.

Health monitoring device 210 may include a device capable of receiving, monitoring, storing, processing, and/or providing a health metric and/or information associated with a health metric, such as a health metric of a user. For example, health monitoring device 210 may include a mobile personal emergency response system (MPERS) that includes one or more sensors for monitoring health metrics, and/or that includes one or more communication interfaces for receiving health metrics from one or more other devices that include one or more sensors for monitoring health metrics (e.g., via a network, such as a short-range wireless communication network). In some implementations, health monitoring device 210 may include a wearable device (e.g., a device worn by a user) that may be attached, for example, to a user or a user's clothing. In some implementations, health monitoring device 210 may transmit a health metric, monitored by the one or more sensors and/or processed by health monitoring device 210, to another device (e.g., medical provider device 220 and/or analytics device 230).

The one or more sensors may include, for example, an accelerometer (e.g., a single axis accelerometer and/or a multiple-axis accelerometer), a barometer, a gyroscope, a microphone, a pressure sensor, a photodiode, a transducer, a location sensor (e.g., a global positioning system (GPS) sensor), a camera, a temperature sensor (e.g., for measuring skin, device, and/or environmental temperature), a moisture sensor (e.g., for measuring, skin, device, and/or environmental moisture), a body resistance sensor (e.g., for measuring electrical resistance), a heat flux sensor, a weather sensor, a proximity sensor, an electric field sensor, a manometer, a stretch sensor, a Galvanic sensor, a heart rate sensor (e.g., a heart rate variability sensor), a glucose level sensor, a blood oxygen saturation sensor (e.g., to detect a blood oxygen level), a gait sensor, a blood pressure sensor, a drug monitoring sensor, an electrocardiogram (ECG) sensor, a medication sensor, an oximeter, a neurological sensor, a weight sensor (e.g., a scale), a body mass sensor, a fall sensor (e.g., to detect when a user has fallen and/or potentially fallen), etc.

Medical provider device 220 may include a device capable of receiving, generating, storing, processing, and/or providing medical record information, such as medical record information associated with a user. For example, medical provider device 220 may include a computing device (e.g., a desktop computer, a server computer, a laptop computer, a tablet computer, an emergency dispatch call center computer, etc.), a mobile device (e.g., a smart phone, a radiotelephone, a personal digital assistant, etc.), or the like. In some implementations, medical provider device 220 may receive medical record information (e.g., input by a medical provider), and/or may transmit medical record information to another device (e.g., analytics device 230). Additionally, or alternatively, medical provider device 220 may receive, process, and/or provide other information (e.g., a health metric, a health alert, etc.).

Analytics device 230 may include a device capable of receiving, generating, storing, processing, and/or providing a health metric, medical record information, and/or information associated with the health metric or medical record information (e.g., a health alert). For example, analytics device 230 may include a computing device (e.g., a desktop computer, a server computer, a laptop computer, a tablet computer, etc.) or the like. In some implementations, analytics device 230 may receive information that identifies a health metric (e.g., from health monitoring device 210) and medical record information (e.g., from medical provider device 220), may analyze the health metric and the medical record information, and may generate a health alert based on the analysis. In some implementations, analytics device 230 may provide the health alert (e.g., via a display, a speaker, and/or another device, such as medical provider device 220).

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

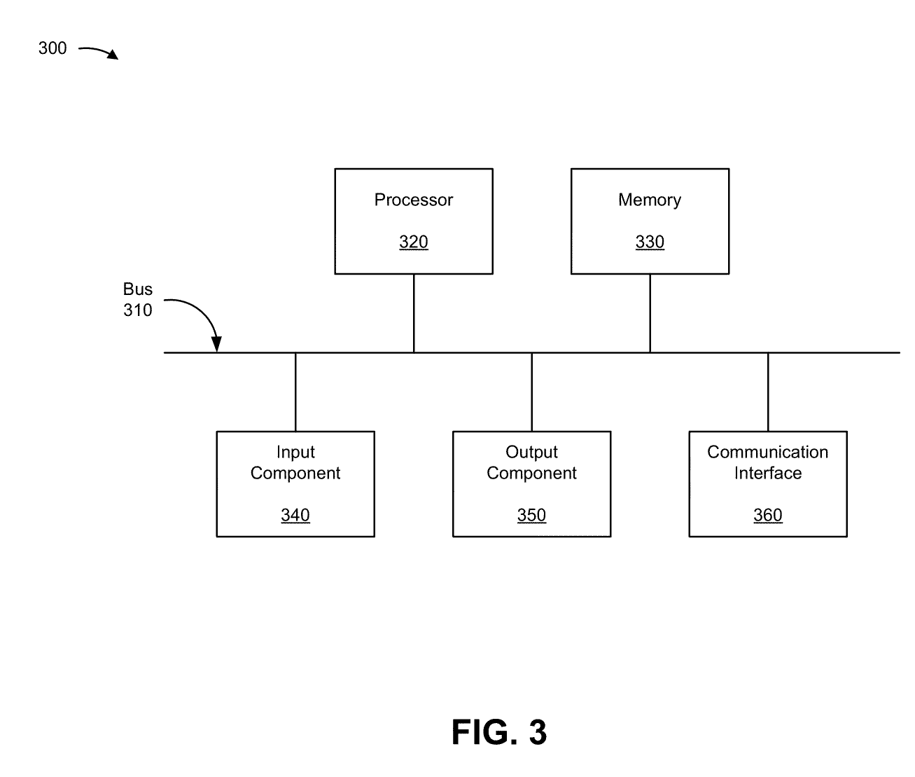

FIG. 3 is a diagram of example components of a device 300. Device 300 may correspond to health monitoring device 210, medical provider device 220, and/or analytics device 230. Additionally, or alternatively, each of health monitoring device 210, medical provider device 220, and/or analytics device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components illustrated in FIG. 3 is provided for explanatory purposes. In practice, device 300 may include additional components, fewer components, different components, or differently arranged components than those illustrated in FIG. 3.

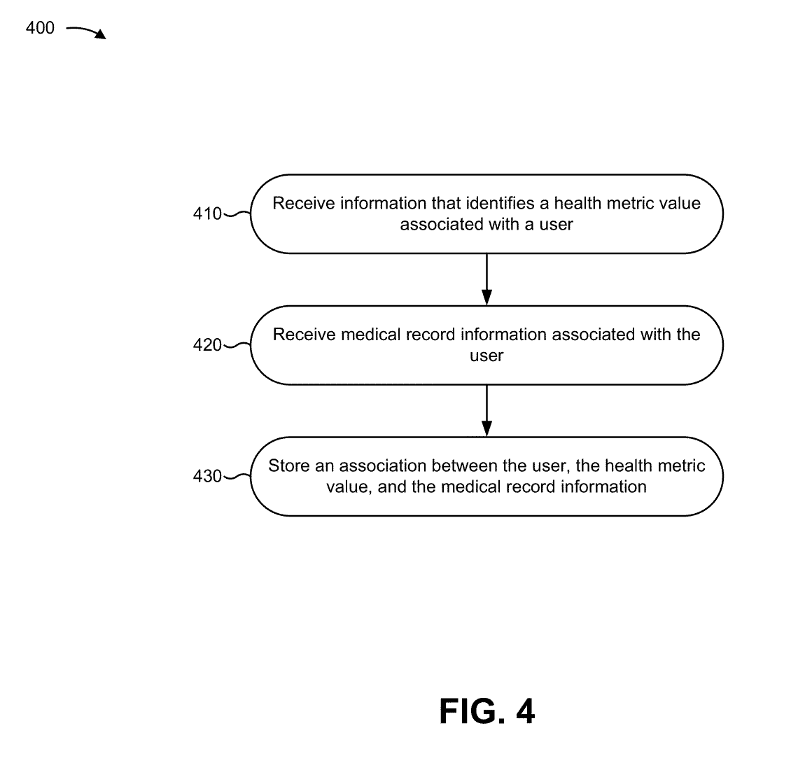

FIG. 4 is a flow chart of an example process 400 for storing health metric values and medical record information associated with a user. In some implementations, one or more process blocks of FIG. 4 may be performed by analytics device 230. In some implementations, one or more process blocks of FIG. 4 may be performed by another device or a group of devices separate from or including analytics device 230, such as health monitoring device 210 and/or medical provider device 220.

As shown in FIG. 4, process 400 may include receiving information that identifies a health metric value associated with a user (block 410). For example, analytics device 230 may receive (e.g., from health monitoring device 210 and/or medical provider device 220) information that identifies a health metric value associated with a user. In some implementations, health monitoring device 210 may determine a health metric value associated with a user (e.g., based on monitoring the user and/or receiving information from another device). Health monitoring device 210 may transmit information that identifies the health metric value to analytics device 230. In some implementations, health monitoring device 210 may transmit the information periodically. Additionally, or alternatively, health monitoring device 210 may transmit the information based on a request received from analytics device 230.

A health metric value (and/or a health metric), as used herein, may include any information, pertaining to a user's health, that may be measured (e.g., by a sensor). For example, a health metric value may include a heart rate measurement (e.g., a resting heart rate, an active heart rate, an average heart rate, etc.), a body measurement (e.g., a weight, a height, a body mass index, a body fat percentage, a body temperature, a weight change, a body resistance, etc.), a voice measurement (e.g., a voice frequency, a voice volume level, a change in a voice, etc.), a blood pressure measurement (e.g., a diastolic blood pressure, a systolic blood pressure, a pulse pressure, a pulse wave, etc.), a nutrition measurement (e.g., an amount of calories consumed, an amount of fat consumed, an amount of food, fat, calories, etc. consumed in a particular time period, a picture of food consumed, etc.), a skin moisture measurement, a glucose measurement (e.g., a blood sugar level), a respiration measurement (e.g., respiration rate), a blood oxygen level measurement, or the like.

Additionally, or alternatively, the health metric value may include, for example, a sleep measurement (e.g., an amount of time spent in different sleep cycles, an amount of time spent sleeping, a sleep quality score, an indication of restlessness, etc.), a fall measurement (e.g., an indication that a user has fallen or has potentially fallen), an activity level measurement and/or an activity score (e.g., based on movement; a number of steps taken; a type of step taken, such as running, walking, limping, low impact, high impact, etc.; a duration between steps and/or between a type of step; a body and/or environmental temperature; a pressure during activity, such as a pressure on a foot sensor; a quantity of stairs climbed; an activity type, such as running, walking, sitting, standing, jumping, falling, driving, sleeping, a type of exercise, etc.; an amount of time spent performing an activity of a particular type; a distance moved; an acceleration; an elevation; a location; an amount of calories burned; a gait measurement; a body orientation; an average heart rate; etc.), an ambient measurement (e.g., a measured light level, a measured temperature, a measured pressure, a measured noise level, a heat flux measurement, a moisture measurement, etc.), or the like.

As an example, a health metric value for a heart rate measurement may include a value of eighty beats per minute. A health metric value may be determined based on a single measurement, a combination of multiple measurements (e.g., of a single health metric, such as an average value of the health metric over time), a combination of multiple health metrics (e.g., with the same or different weight values applied to the multiple health metrics), or the like.

As further shown in FIG. 4, process 400 may include receiving medical record information associated with the user (block 420). For example, analytics device 230 may receive, from medical provider device 220, medical record information associated with the user. In some implementations, a medical provider (e.g., a doctor, a nurse, a caregiver, a pharmacist, a psychiatrist, a network operator, a telematics provider, a call center technician, etc.), may input medical record information, associated with the user, into medical provider device 220 (e.g., via a web site). Medical provider device 220 may transmit the medical record information to analytics device 230. In some implementations, medical provider device 220 may transmit the information periodically. Additionally, or alternatively, medical provider device 220 may transmit the information based on a request received from analytics device 230. In some implementations, a user may provide the medical record information to analytics device 230 (e.g., via a user device, such as a computing device and/or a mobile device).

Medical record information, as used herein, may refer to information pertaining to a user's health and/or medical records. For example, medical record information may include medication information (e.g., a type of medication, a combination of medications, a received vaccination, a medication history, etc.), medication dosage information (e.g., a dosage of medication taken, an amount of medication taken, a time at which mediation is taken, a dosage taken at a particular time, etc.), allergy information (e.g., allergens to which a user is allergic, such as foods, pollens, animals, medications, etc.; symptoms of allergies, such as itching, hives, congestion, coughing, etc.; etc.), information that identifies a health condition and/or disease of a user (e.g., Alzheimer's disease, Parkinson's disease, diabetes, a chronic health condition, a temporary health condition, etc.), illness information (e.g., a type of illness contracted by a user, such as influenza, chicken pox, a broken bone, etc.; a cause of an illness; a time period associated with an illness; etc.), hospitalization information (e.g., a hospital stay, a surgery, a medical procedure, etc.), laboratory test information (e.g., a blood test and/or urine test result, such as a blood glucose level, a sodium level, a potassium level, a urea level, a creatine level, a protein level, a hematocrit level, a blood type, a cholesterol level, etc.; x-ray information and/or results, etc.), or the like.

Additionally, or alternatively, medical record information may include, for example, family history information (e.g., a disease history, a psychological history, a physiological history, a chronic illness, etc.), a health observation (e.g., a height, a weight, a mood, a physical observation, a psychological observation, an indication of slowing activity levels, an indication of a fall, etc.), nutrition information (e.g., eating habits, caloric intake, fat content, an amount of fat eaten in a time period, an indication of a meal eaten by the user, information based on a picture of a meal, a location of a user when a meal is eaten, etc.), exercise information (e.g., a time when a user exercises, an amount of time spent exercising, a type of exercise, etc.), life event information (e.g., a marriage, a birth of a child, a death of a family member, a change in geographic location, etc.), physiological information (e.g., physical characteristics, such as baldness), psychological information (e.g., depression, happiness level, anxiety level, etc.), demographic information (e.g., age, gender, income level, geographic location, etc.), or the like. In some implementations, the medical record information may include a health metric value. Alternatively, the medical record information may be different from the health metric value.

In some implementations, the medical record information may include and/or may be associated with a time (e.g., a time that the medical information was recorded, a time associated with information in a medical record, a time that the medical record information was received, etc.). For example, a medication may be associated with a start time (e.g., when the user started taking the medication), a usage time (e.g., when the user takes the medication), an end time (e.g., when the user stops taking the medication), or the like. As another example, a condition, a disease, and/or an illness may be associated with a time that the condition/disease/illness was contracted and/or diagnosed, a time that the condition/disease/illness was cured and/or treated, a time period during which the user had the condition/disease/illness, or the like. Other medical record information may be associated with a time, such as a time that the information was recorded, a time that the user was impacted by the information, etc.

As further shown in FIG. 4, process 400 may include storing an association between the user, the health metric value, and the medical record information (block 430). For example, analytics device 230 may store, in a data structure, an association between the user, the health metric value, and the medical record information. In some implementations, analytics device 230 may store health metrics and medical record information for multiple users, and may use the information from the multiple users to infer and/or analyze information associated with other users, as discussed elsewhere herein. In some implementations, analytics device 230 may repeat process blocks 410, 420, and/or 430 for multiple health metrics associated with one or more users.

While a series of blocks has been described with regard to FIG. 4, the blocks and/or the order of the blocks may be modified in some implementations. Additionally, or alternatively, non-dependent blocks may be performed in parallel. Further, one or more blocks may be omitted.

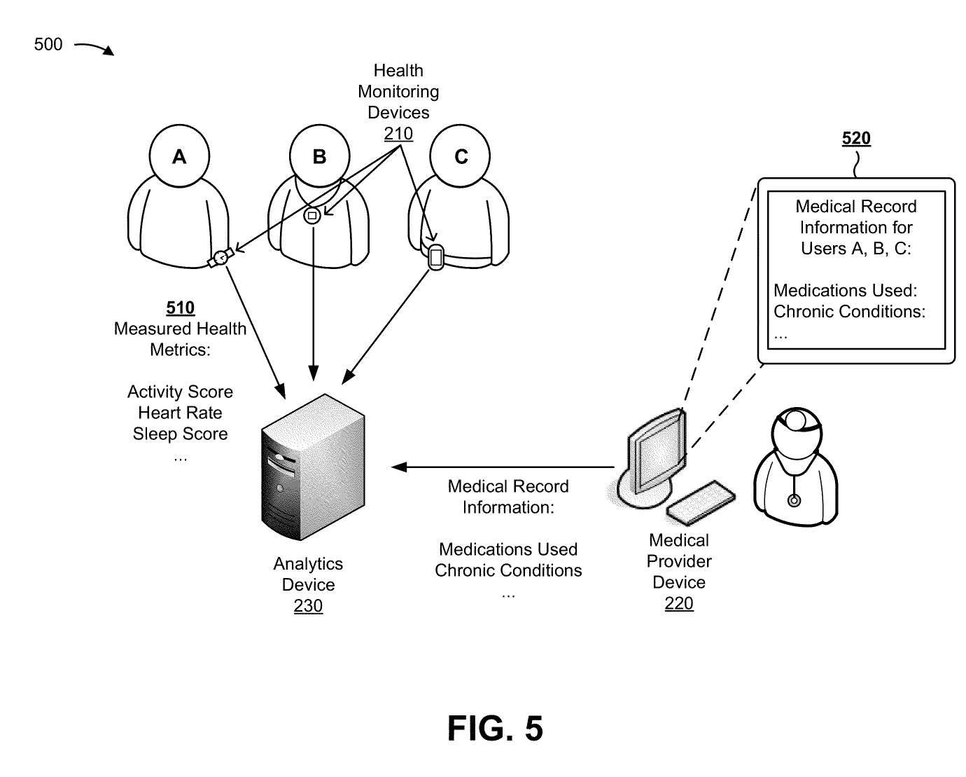

FIG. 5 is a diagram of an example implementation 500 relating to example process 400 shown in FIG. 4. As shown in FIG. 5, health metrics and medical record information for multiple users, labeled Users A, B, and C, may be transmitted to and/or received by analytics device 230.

As shown by reference number 510, health monitoring devices 210 associated with Users A, B, and C may measure various health metrics of the users, such as an activity score, a heart rate, and a sleep score. Health monitoring devices 210 may transmit the measured health metrics to analytics device 230.

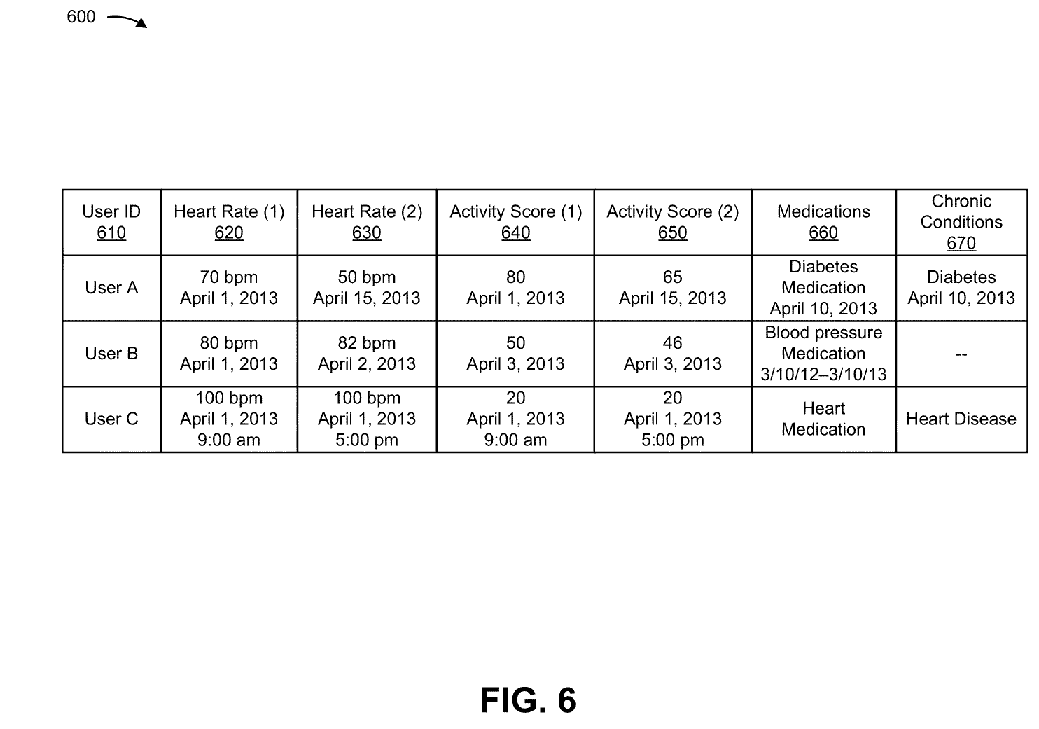

As shown by reference number 520, a medical provider may input medical record information, such as medications used and chronic conditions, into medical provider device 220. Medical provider device 220 may transmit the medical record information to analytics device 230. Analytics device 230 may store information that identifies the users (e.g., Users A, B, and C), the health metrics of the users (e.g., an activity score, a heart rate, and a sleep score), and the medical record information of the users (e.g., medications used and chronic conditions). In some implementations, analytics device 230 may store the information in a data structure, discussed herein in connection with FIG. 6.

As indicated above, FIG. 5 is provided as an example. Other examples are possible and may differ from what is depicted in FIG. 5 and/or what is described with regard to FIG. 5.

FIG. 6 is a diagram of an example data structure 600 for storing health metric values and medical record information associated with one or more users. Data structure 600 may be stored in a memory device (e.g., a RAM, a hard disk, etc.) associated with one or more devices and/or components shown in FIGS. 2 and/or 3. For example, data structure 600 may be stored by analytics device 230. Data structure 600 may include a collection of fields, such as a user identifier (ID) field 610, heart rate fields 620-630, activity score fields 640-650, medications field 660, and chronic conditions field 670.

User ID field 610 may store information that identifies a user. For example, user ID field 610 may store a name of a user, a unique identifier that identifies a user (e.g., a social security number, an insurance number, or another unique string of characters), or the like.

Heart rate fields 620-630 may store information that identifies a measured heart rate value of a user identified in user ID field 610. For example, heart rate fields 620-630 may store information identifying a number of times a user's heart beats per minute (bpm). Furthermore, heart rate fields 620-630 may store information that identifies a time at which the user's heart rate was measured. For example, a first heart rate field 620 may identify a number of beats per minute measured at a first time, and a second heart rate field 630 may identify a number of beats per minute measured at a second time.

Activity score fields 640-650 may store information that identifies a measured and/or calculated activity score for a user identified in user ID field 610. For example, activity score fields 640-650 may store information identifying a number that represents an activity score calculated based on a number of steps taken by a user, a distance traveled by a user, a heart rate of the user, and/or other measured information that indicates an activity level of the user. Furthermore, activity score fields 640-650 may store information that identifies a time at which the user's activity score was measured and/or calculated. For example, a first activity score field 640 may identify an activity score calculated at a first time, and a second activity score field 650 may identify an activity score calculated at a second time.

Medications field 660 may store information that identifies one or more medications that have been prescribed to a user identified in user ID field 610. For example, medications field 660 may store a name of a medication, a prescription number associated with a medication, or the like. Furthermore, medications field 660 may store information that identifies a date and/or time associated with the identified medication(s), such as a date that the medication was prescribed, a date that the medication was started (e.g., when the user started taking the medication), a date that the medication was stopped (e.g., when the user stopped taking the medication), a usage date/time of the medication (e.g., when the user last used the medication), or the like.

Chronic conditions field 670 may store information that identifies one or more chronic conditions that have been diagnosed for a user identified in user ID field 610. For example, chronic conditions field 670 may store a name of a chronic condition. Furthermore, chronic conditions field 670 may store information that identifies a date and/or time associated with the identified chronic condition(s), such as a date that the condition was diagnosed, a date that the user first experienced symptoms of the condition, or the like.

Information associated with a single user may be represented as a row in data structure 600. For example, the first row in data structure 600 may correspond to information associated with User A, who had a measured heart rate of 70 bpm on Apr. 1, 2013, a measured heart rate of 50 bpm on Apr. 15, 2013, a calculated activity score of 80 on Apr. 1, 2013, a calculated activity score of 65 on Apr. 15, 2013, who started a diabetes medication on Apr. 10, 2013, and who was diagnosed with diabetes on Apr. 10, 2013.

Data structure 600 includes fields 610-670 for explanatory purposes. In practice, data structure 600 may include additional fields, fewer fields, different fields, or differently arranged fields than those shown in FIG. 6 and/or described herein with respect to data structure 600. For example, while data structure 600 is described as storing information that identifies a heart rate value and an activity score value, data structure 600 may store information that identifies other health metric values in some implementations. As another example, while data structure 600 is described as storing medication information and chronic condition information, data structure 600 may store other medical record information in some implementations.

Furthermore, while data structure 600 is represented as a table with rows and columns, in practice, data structure 600 may include any type of data structure, such as a linked list, a tree, a hash table, a database, or any other type of data structure. In some implementations, data structure 600 may include information generated by a device and/or component. Additionally, or alternatively, data structure 600 may include information provided from another source, such as information provided by a user and/or information automatically provided by a device.

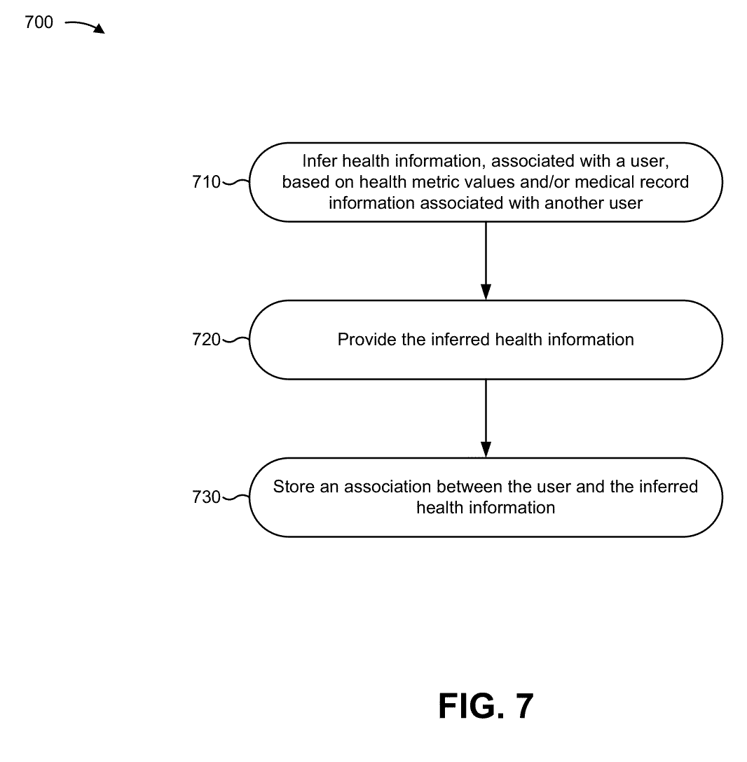

FIG. 7 is a flow chart of an example process 700 for inferring health information associated with a user. In some implementations, one or more process blocks of FIG. 7 may be performed by analytics device 230. In some implementations, one or more process blocks of FIG. 7 may be performed by another device or a group of devices separate from or including analytics device 230, such as health monitoring device 210 and/or medical provider device 220.

As shown in FIG. 7, process 700 may include inferring health information, associated with a user, based on health metric values and/or medical record information associated with another user (block 710). For example, analytics device 230 may infer information, associated with a user, based on one or more health metric values and/or medical record information associated with one or more other users. The health information may include, for example, a health metric value, medical record information, or other information pertaining to a user's health.

In some implementations, analytics device 230 may infer the health information by comparing stored health information for a user to stored health information for one or more other users, and determining missing (e.g., unstored) health information for the user based on other known (e.g., stored) health information for the other users. For example, a group of users may have a high heart rate, and a threshold quantity of those users may have a chronic condition of heart disease. Based on determining that a threshold quantity of users with a high heart rate also have heart disease, analytics device 230 may determine that other users with a high heart rate also have heart disease. Analytics device 230 may infer health information based on one or more thresholds associated with one or more categories of health metrics and/or medical record information. In some implementations, the health information may include a prediction of future health information.

Additionally, or alternatively, analytics device 230 may infer the health information based on one or more machine learning techniques (e.g., supervised or unsupervised machine learning techniques). The machine learning techniques may include, for example, pattern recognition (e.g., classification), neural network analysis (e.g., an artificial neural network), support vector machine, regression analysis (e.g., binary regression), collaborative filtering, clustering (e.g., hierarchical clustering, K-means clustering, etc.), principal component analysis, outlier detection, singular value decomposition, or the like.

In some implementations, analytics device 230 may use health information associated with one or more users (e.g., stored in data structure 600) as training data to train a machine learning technique. Analytics device 230 may apply the trained machine learning technique to health information associated with a particular user to infer other health information for the particular user. For example, a user's body mass index may be inferred based on height and weight of the user, an amount of calories burned may be inferred based on heart rate and/or activity levels, an allergic reaction may be inferred from an increase in heart rate after eating a particular food, possible future contraction of a disease (e.g., heart disease, Alzheimer's disease, Parkinson's disease, etc.) may be inferred from health information (e.g., nutrition information, medication information, dosage information, exercise information, etc.), an amount of insulin that a user should take may be inferred from health information (e.g., a glucose level, a heart rate, an activity level, nutrition information, etc.), etc.

As another example, analytics device 230 may determine that a set of users with a particular allergy had decreased activity levels after being prescribed a particular medication. Analytics device 230 may infer that another user with the particular allergy should not be prescribed the particular medication.

In some implementations, analytics device 230 may infer a future health problem of a user by clustering information regarding other users with the same type of health problem, and by inferring predictors of the health problem based on health information associated with the cluster of users. If the predictors of the user and the cluster of users are similar (e.g., a threshold quantity of the predictors match, are within a range, etc.), then analytics device 230 may infer that the user is at risk of developing the health problem. In some implementations, the inferred information may include a likelihood of the user contracting the future health problem and/or an estimated time that the user may develop the future health problem.

In some implementations, analytics device 230 may determine a change that may improve a user's health, and may suggest the change (e.g., a change to diet, exercise, sleep habits, activity levels, medications, supplements, etc.).

As further shown in FIG. 7, process 700 may include providing the inferred health information (block 720), and storing an association between the user and the inferred health information (block 730). For example, analytics device 230 may provide the inferred health information to medical provider device 220 and/or to another device (e.g., a user device associated with a user to which the health information pertains).

In some implementations, analytics device 230 may receive information indicating that the health information is confirmed. For example, analytics device 230 may infer that a user has a chronic condition of heart disease, and may send an indication of this inference to medical provider device 220. A medical provider may view the indication (e.g., via a user interface of medical provider device 220), and may input information indicating whether the inference is true or false (e.g., whether the user has or does not have heart disease). Based on the information input by the medical provider, analytics device 230 may store (or not store) the inferred information. For example, if the medical provider indicates that the inference is false, analytics device 230 may not store the inferred information. Conversely, if the medical provider indicates that the inference is true, analytics device 230 may store the inferred information.

In some implementations, analytics device 230 may receive information that identifies a criterion (e.g., via input from a user), and may provide the inferred information based on the criterion being satisfied. The criterion may specify, for example, that the inferred information is to be provided when a particular type of health information is inferred (e.g., a chronic condition; a particular chronic condition, such as heart disease; etc.).

In some implementations, analytics device 230 may store the inferred information in a data structure (e.g., data structure 600). The data structure may store information that identifies an association between a user, a health metric value, and/or medical record information, as discussed elsewhere herein. Additionally, or alternatively, analytics device 230 may provide the inferred information to another device (e.g., medical provider device 220) for storage.

While a series of blocks has been described with regard to FIG. 7, the blocks and/or the order of the blocks may be modified in some implementations. Additionally, or alternatively, non-dependent blocks may be performed in parallel. Further, one or more blocks may be omitted.

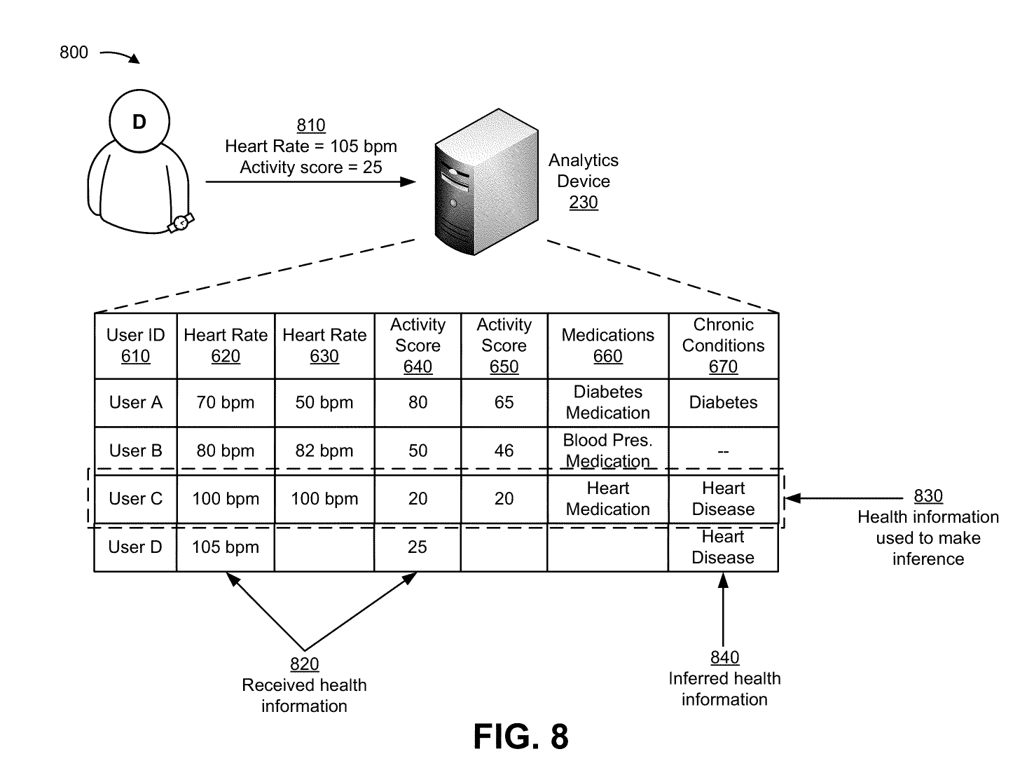

FIG. 8 is a diagram of an example implementation 800 relating to example process 700 shown in FIG. 7. In example implementation 800, analytics device 230 may infer health information about a user, identified as User D, based on stored health information associated with other users, identified as Users A, B, and C.

As shown by reference number 810, analytics device 230 may receive health information indicating that User D has a heart rate of 105 bpm and an activity score of 25. As shown by reference number 820, analytics device 230 may store the received health information in a data structure (e.g., data structure 600). Analytics device 230 may not yet have received other information associated with User D, such as medications being used by User D, chronic conditions of User D, etc.

As shown by reference number 830, analytics device 230 may use the received health information, associated with User D, as well as health information associated with one or more other users, to determine other health information associated with User D. For example, analytics device 230 may determine that both User C and User D have a heart rate of 100 bpm or higher, and that both User C and User D have an activity score of 25 or lower. As shown by reference number 840, based on this comparison, analytics device 230 may infer that User D has heart disease because User C has heart disease.

In some implementations, analytics device 230 may determine a threshold for comparison (e.g., a heart rate of 100 bpm and/or an activity score of 25) by clustering information regarding users associated with particular health information. For example, User C may be included in a cluster of users with heart disease. Analytics device 230 may determine an average heart rate and an average activity score for users in the cluster, and may use the average heart rate (e.g., 100 bpm) and the average activity score (e.g., 25) as a threshold to determine whether User D is to be associated with inferred health information indicating that User D has heart disease.

As indicated above, FIG. 8 is provided as an example. Other examples are possible and may differ from what is depicted in FIG. 8 and/or what is described with regard to FIG. 8.

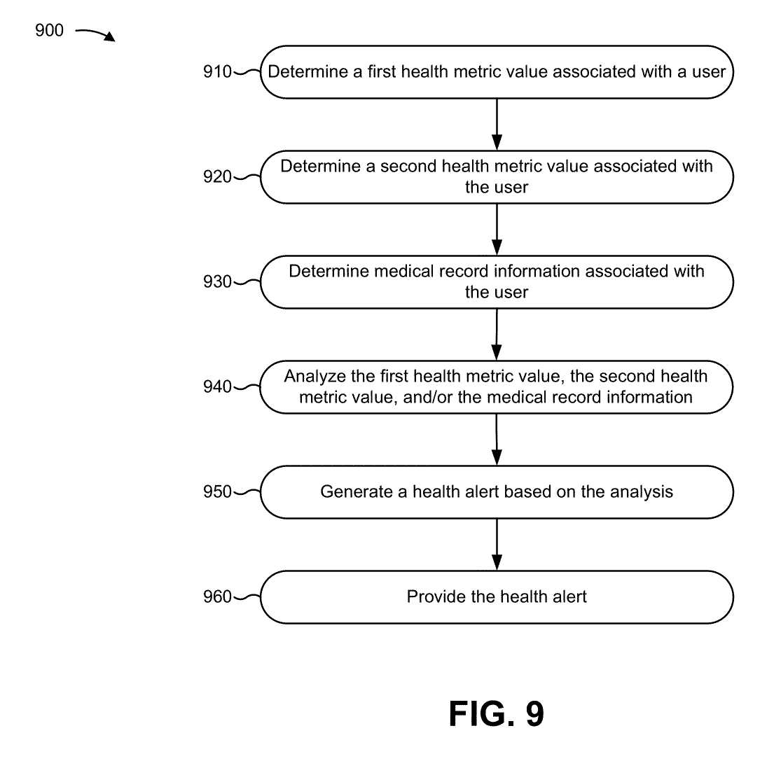

FIG. 9 is a flow chart of an example process 900 for generating and providing a health alert based on an analysis of a health metric value and/or medical record information. In some implementations, one or more process blocks of FIG. 9 may be performed by analytics device 230. In some implementations, one or more process blocks of FIG. 9 may be performed by another device or a group of devices separate from or including analytics device 230, such as health monitoring device 210 and/or medical provider device 220.

As shown in FIG. 9, process 900 may include determining a first health metric value associated with a user (block 910), and determining a second health metric value associated with the user (block 920). For example, analytics device 230 may determine the first health metric value and the second health metric value associated with the user. In some implementations, analytics device 230 may determine the health metric values based on information received from another device (e.g., health monitoring device 210) and/or information stored in a data structure (e.g., data structure 600).

The health metric values may be associated with values of a health metric at different points in time. For example, the health metric values may be associated with a heart rate. Assume that the first health metric value represents a heart rate of the user at a first time, and the second health metric value represents a heart rate of the user at a second time (e.g., later than the first time).

As further shown in FIG. 9, process 900 may include determining medical record information associated with the user (block 930). For example, analytics device 230 may determine the medical record information based on information received from another device (e.g., medical provider device 220) and/or information stored in a data structure (e.g., data structure 600). In some implementations, the medical record information may be associated with a particular point in time.

As further shown in FIG. 9, process 900 may include analyzing the first health metric value, the second health metric value, and/or the medical record information (block 940), and generating a health alert based on the analysis (block 950). For example, analytics device 230 may analyze the first health metric value, the second health metric value, and/or the medical record information using one or more analysis techniques. An analysis technique may include, for example, a threshold analysis and/or a machine learning technique.

In some implementations, analytics device 230 may determine that a health metric value satisfies a threshold, and may generate a health alert based on the determination. For example, analytics device 230 may determine that a user's heart rate has dropped below a threshold or risen above a threshold, and may generate a health alert indicating that the user's heart rate value satisfies the threshold.

Additionally, or alternatively, analytics device 230 may determine that a change in the health metric value satisfies a threshold, and may generate a health alert based on the determination. For example, analytics device 230 may determine a difference between the first health metric value and the second health metric value, may determine that the difference satisfies a threshold (e.g., that the user's heart rate has changed by more than a threshold value), and may generate a health alert indicating that the change in the user's health metric value satisfies a threshold.

In some implementations, analytics device 230 may determine a correlation between a change in the health metric value and the medical record information. For example, analytics device 230 may determine that a user's heart rate, activity level, sleep level, etc. has changed (e.g., decreased) a threshold amount between a first time and a second time. Analytics device 230 may further determine that medical record information, associated with the user, changed at a third time between the first and second time. For example, analytics device 230 may determine that the user started taking a medication between the first and second times. From this information, analytics device 230 may infer that the change in medical record information (e.g., starting a medication) may be a cause of the change in the health metric value (e.g., the change in heart rate, activity level, sleep level, etc. over time).

As further shown in FIG. 9, process 900 may include providing the health alert (block 960). For example, analytics device 230 may provide the health alert to another device, such as health monitoring device 210, medical provider device 220, and/or another device (e.g., a user device of a user associated with the health alert). Additionally, or alternatively, analytics device 230 may provide the health alert for storage (e.g., in data structure 600). In this way, a user and/or a medical provider may be notified about medical issues that may require medical attention.

While a series of blocks has been described with regard to FIG. 9, the blocks and/or the order of the blocks may be modified in some implementations. Additionally, or alternatively, non-dependent blocks may be performed in parallel. Further, one or more blocks may be omitted.

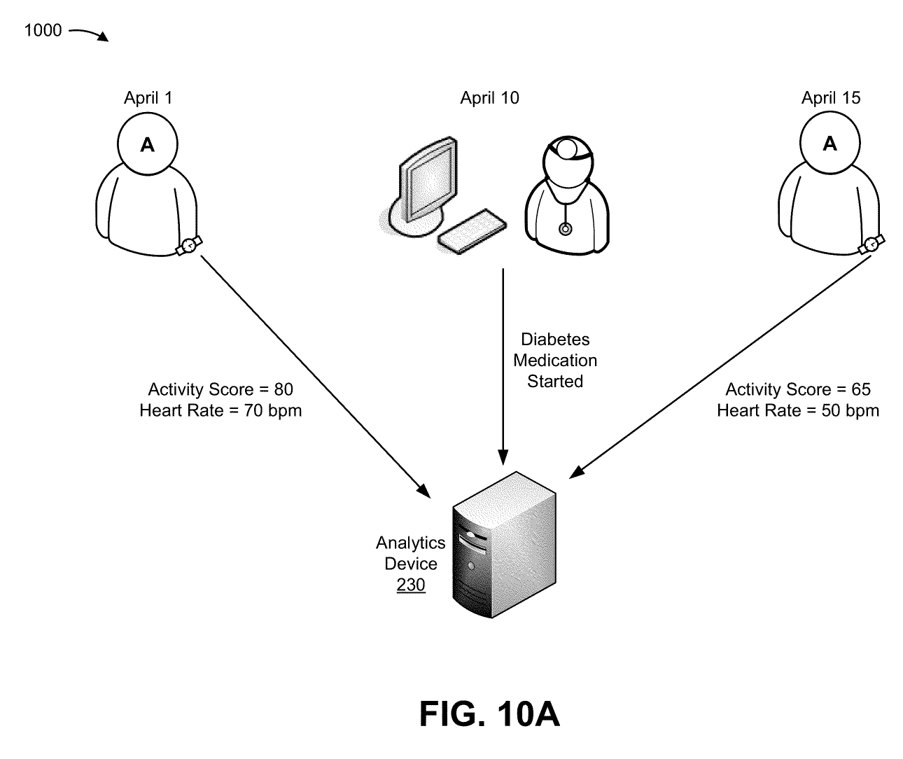

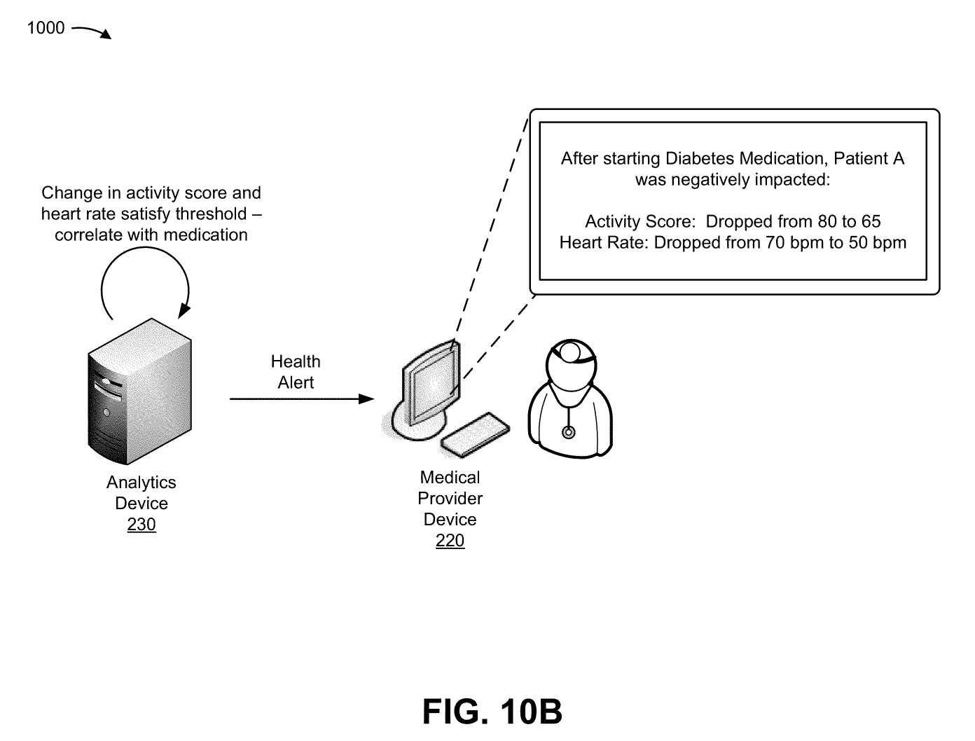

FIGS. 10A and 10B are diagrams of an example implementation 1000 relating to example process 900 shown in FIG. 9. Example implementation 1000 depicts an implementation where analytics device 230 determines a change in a health metric, determines a correlation between the change in the health metric and a change in medical record information, generates a health alert based on determining the correlation, and provides the health alert.

As shown in FIG. 10A, assume that on April 1, analytics device 230 receives, from health monitoring device 210 associated with a user identified as User A, two health metrics. Assume that the health metrics indicate that User A has an activity score of 80 and a heart rate of 70 bpm on April 1. Further, assume that on April 10, analytics device 230 receives, from medical provider device 220, an indication that User A has started taking diabetes medication on April 10. Finally, assume that on April 15, analytics device 230 receives, from health monitoring device 210 associated with User A, an indication that User A has an activity score of 65 and a heart rate of 50 bpm on April 15.

As shown in FIG. 10B, analytics device 230 may analyze the health metric values (e.g., the activity score and the heart rate) and the medical record information (e.g., the medication information) to determine that a change in the activity score and the change in the heart rate satisfy a threshold. Further, analytics device 230 may determine that there is a correlation between the changes and User A beginning the diabetes medication. Analytics device 230 may infer the correlation based on the dates associated with the received information. For example, analytics device 230 may infer that the changes in the health metrics between April 1 and April 15 may have been caused by the diabetes medication started on April 10. Additionally, or alternatively, analytics device 230 may determine that the diabetes medication had a similar effect on other users based on information stored in a data structure (e.g., data structure 600), and may infer the correlation based on the stored information.

As further shown in FIG. 10B, analytics device 230 may generate a health alert based on the inferred information and/or the changes in the health metrics satisfying one or more thresholds, and may provide the health alert to medical provider device 220. Medical provider device 220 may provide received information, associated with the health alert, via a user interface. For example, medical provider device 220 may display an indication that User A was negatively impacted by the diabetes medication, and may display information that identifies the negative impact (e.g., the change in activity score and heart rate), as shown.

As indicated above, FIGS. 10A and 10B are provided as an example. Other examples are possible and may differ from what is depicted in FIGS. 10A and 10B and/or what is described with regard to FIGS. 10A and 10B.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive information that identifies a first health metric value associated with a user,
the first health metric value being associated with a first time;
receive information that identifies a second health metric value associated with the user,
the second health metric value being associated with a second time that is different from the first time;
receive medical record information associated with the user,
the medical record information being associated with a third time, and
the medical record information being different from the first health metric value and the second health metric value;
infer a relationship between the first health metric value, the second health metric value, and the medical record information, based on the first time, the second time, and the third time; and
provide an indication of the inferred relationship.

2. The device of claim 1, where the one or more processors, when receiving the information that identifies the first health metric value or the second health metric value, are further to:
receive the information that identifies the first health metric value or the second health metric value from a mobile personal emergency response system that determines the first health metric value or the second health metric value based on a sensor used to measure the first health metric value or the second health metric value.

3. The device of claim 1, where the first health metric value and the second health metric value identify at least one of:
a heart rate measurement associated with the user;
an activity level measurement associated with the user;
a sleep measurement associated with the user;
a blood pressure measurement associated with the user;
a temperature measurement associated with the user;
a glucose level measurement associated with the user;
a blood oxygen level measurement associated with the user; or
a respiration measurement associated with the user.

4. The device of claim 1, where the medical record information identifies at least one of:
medication information associated with the user;
allergy information associated with the user;
a health condition associated with the user;
nutritional information associated with the user; or
exercise information associated with the user.

5. The device of claim 1, where the one or more processors are further to:
determine that a difference between the first health metric value and the second health metric value satisfies a threshold; and
where the one or more processors, when inferring the relationship, are further to:
infer the relationship based on determining that the difference between the first health metric value and the second health metric value satisfies the threshold.

6. The device of claim 1, where the one or more processors, when inferring the relationship, are further to:
infer the relationship based on applying a machine learning technique to other health metric values and other medical record information,
the other health metric values and the other medical record information being associated with other users.

7. The device of claim 1,
where the medical record information includes information identifying a medication associated with the third time;
where the one or more processors, when inferring the relationship, are further to:
infer that the medication is a cause of the difference between the first health metric value and the second health metric value; and
where the one or more processors, when providing the indication, are further to:
provide information indicating that the medication is a cause of the difference.

8. A system, comprising:
one or more devices to:
determine information that identifies a first health metric value associated with a user,
the first health metric value being associated with a first time;
determine information that identifies a second health metric value associated with the user,
the second health metric value being associated with a second time that is different from the first time;
determine medical record information associated with the user,
the medical record information being associated with a third time;
determine that a difference between the first health metric value and the second health metric value satisfies a threshold;
infer, based on determining that the difference satisfies the threshold, a relationship between the first health metric value, the second health metric value, and the medical record information, based on the first time, the second time, and the third time; and
provide an indication of the inferred relationship.

9. The system of claim 8, where the one or more devices, when receiving the information that identifies the first health metric value or the second health metric value, are further to:
receive the information that identifies the first health metric value or the second health metric value from a mobile personal emergency response system that determines the first health metric value or the second health metric value based on a sensor used to measure the first health metric value or the second health metric value.

10. The system of claim 8, where the first health metric value and the second health metric value identify at least one of:
a heart rate measurement associated with the user;
an activity level measurement associated with the user;
a sleep measurement associated with the user;
a blood pressure measurement associated with the user;
a temperature measurement associated with the user;
a glucose level measurement associated with the user;
a blood oxygen level measurement associated with the user; or
a respiration measurement associated with the user.

11. The system of claim 8, where the medical record information identifies at least one of:
medication information associated with the user;
allergy information associated with the user;
a health condition associated with the user;
nutritional information associated with the user; or
exercise information associated with the user.

12. The system of claim 8, where the one or more devices, when inferring the relationship, are further to:
infer the relationship based on analyzing other health metric values and other medical record information,
the other health metric values and the other medical record information being associated with other users that differ from the user.

13. The system of claim 8, where the one or more devices are further to:
determine other health metric values and other medical record information associated with other users that differ from the user;
apply a machine learning algorithm to the other health metric values, the other medical record information, the first health metric value, the second health metric value, and the medical record information; and
where the one or more devices, when inferring the relationship, are further to:
infer the relationship based on applying the machine learning algorithm.

14. The system of claim 8,
where the medical record information includes information identifying a medication associated with the third time;
where the one or more devices, when inferring the relationship, are further to:
infer that the medication is a cause of the difference between the first health metric value and the second health metric value; and
where the one or more devices, when providing the indication, are further to:
provide information indicating that the medication is a cause of the difference.

15. A method, comprising:
receiving, by a device, information that identifies a first health metric value associated with a user;
receiving, by the device, information that identifies a second health metric value associated with the user,
the second health metric value being different from the first health metric value;
receiving, by the device, medical record information associated with the user,
the medical record information being different from the first health metric value and the second health metric value;
determining, by the device, that a difference between the first health metric value and the second health metric value satisfies a threshold;
inferring, by the device and based on determining that the difference satisfies the threshold, a relationship between the first health metric value, the second health metric value, and the medical record information; and
providing, by the device, an indication of the inferred relationship.

16. The method of claim 15, where receiving the information that identifies the first health metric value or the second health metric value further comprises:
receiving the information that identifies the first health metric value or the second health metric value from a mobile personal emergency response system that determines the first health metric value or the second health metric value based on a sensor used to measure the first health metric value or the second health metric value.

17. The method of claim 15, where inferring the relationship further comprises:
inferring the relationship based on analyzing other health metric values and other medical record information,
the other health metric values and the other medical record information being associated with other users that differ from the user.

18. The method of claim 15, further comprising:
determining other health metric values and other medical record information associated with other users that are different from the user;
applying a machine learning algorithm to the other health metric values, the other medical record information, the first health metric value, the second health metric value, and the medical record information; and
where inferring the relationship further comprises:
inferring the relationship based on applying the machine learning algorithm.

19. The method of claim 15, further comprising:
determining a first time associated with the first health metric;
determining a second time associated with the second health metric,
the second time being different from the first time;
determining a third time associated with the medical record information; and
where inferring the relationship further comprises:
inferring the relationship based on the first time, the second time, and the third time.

20. The method of claim 19,
where the medical record information includes information identifying a medication associated with the third time;
where inferring the relationship further comprises:
inferring that the medication is a cause of the difference between the first health metric value and the second health metric value; and
where providing the indication further comprises:
providing information indicating that the medication is a cause of the difference.
